(19) United States
(12) Patent Application Publication
(10) Pub. No.: US 2009/0256970 A1
(43) Pub. Date: Oct. 15, 2009

(54) Teleprompter

(76) Inventors: Robert A. Bilbrey, Orinda, CA (US); Mark Ross Ditmanson, Los Gatos, CA (US)

Correspondence Address: John Nielsen;RANDICK O'DEA & TOOLIATOS, LLP, 5000 HOPYARD ROAD, SUITE 400, PLEASANTON, CA, 94588, US

(21) Appl. No.: 12/101,503

(22) Filed: Apr. 11, 2008

(51) Int. Cl. H04N 5/222

(52) U.S. Cl. 348/722

(57) ABSTRACT

The teleprompter described herein allows for rapid adjustment of the camera position and height, beam splitter mirror assembly height and angle, tripod mounting, as well as additional accessories including counter weights, shoulder pads, batteries and feedback monitors. Further, these adjustments do not require the use of tools. Additionally, the invention described herein provides a second, lower plane of contact for camera mounting which allows for the use of heavier cameras.

### 1. BACKGROUND OF THE INVENTION

The elements of teleprompting have been evolving for decades beginning with paper roll prompting devices to the modern LCD panel driven units of today. Today's teleprompters typically present textual material to the ‘on air’ talent on an angled semi-transparent mirror known as a beam splitter. The camera or video camera is behind the beam splitter, at the mirror centerline. Thus the talent reads text with eyes pointed directly at the camera lens. Due to the seemingly direct eye contact with the viewer, an impression is created that the presenter is speaking extemporaneously and not reading the material.

Due to the limitations in the current state of the art, a new and improved teleprompter device is needed to accommodate, within a single mechanism, the wide variety of sizes, shapes and weights of video cameras currently marketed. This invention, unlike any previous teleprompting devices, addresses all of the teleprompting requirements in a robust and economical fashion.

To improve stability, the ideal teleprompter needs to provide a means to keep the center of gravity, with respect to a tripod pivot, as low as possible. The center of gravity of the teleprompting system should be oriented vertically as close as possible to the same tripod pivot center. The camera lens should be as close as possible to the surface of the reflecting mirror of the Teleprompter. The camera lens should be vertically as close as possible to the center of the aforementioned reflecting mirror. Since the image that a camera records radiates into the lens is a rectangular cone, if the lens is too far back from the mirror, elements of the hood, or of the frame that supports the mirror, might interfere with the cone. This effect is made more difficult with wide angle lenses, and by the very wide image of the new wide screen formats.

The presenter tends to read the scrolling text near the center of the display image reflected off of the beam-splitter. Since this display image is centered on the mirror, the eyes of the presenter are aimed at the vertical mid-point of the mirror. Thus if the camera lens behind the beam-splitter is centered on the mirror it will appear to the TV viewer that the presenter is looking directly at the eyes of the viewer.

In certain shooting situations the presenter may be positioned higher or lower in the video frame. In these situations the angle of the beam-splitter mirror assembly needs to be adjusted from the standard 45 degree position to avoid text being cut off from the presenter's view at these angles.

The unit needs to be quickly and easily disassembled for storage or transit purposes. There should be adjustable stops available to quickly reposition the camera and mirror systems. It should be light weight for “shoulder” use. Existing teleprompters do not accomplish all of the above goals, which reduces their utility.

The difficulty in achieving all the above goals in a single instrument is primarily due to the wide range of sizes and weights of commonly used video cameras. For instance, center-of-gravity problems are caused by camera weights varying from 20 pounds to less than 1 pound. Center-of-gravity positioning is especially critical where the system is coupled to a motor driven, remotely controlled camera mount. The lens to mounting surface heights can vary from 1 inch to six inches and more. The distance from the front edge of the camera lens horizontally to the center of the camera mounting threaded socket can vary from about one-half inch to 8 inches.

A simpler, lower cost teleprompter version is also desirable for certain users such as many school video classrooms as well as mobile shoulder-mount operators. These teleprompter applications are often configured with smaller and lighter cameras. Speed and simplicity of setup is often important to these users.

A state-of-the-art teleprompter design needs to embody the full range of the above specifications in a simple, rugged, light weight and reasonably priced instrument to satisfy the needs of a user base ranging from elementary school children to studio professionals.

### 2. SUMMARY AND OBJECTS OF THE INVENTION

The invention described herein allows for rapid adjustment of the camera horizontal position and height, beam splitter mirror assembly height and angle, tripod mounting, as well as addition of accessories including counter weights, shoulder pads, batteries and feedback monitors. Further, these adjustments do not require the use of tools. Additionally, the invention described herein provides a second, lower plane of contact for camera mounting which allows for the use of heavier cameras. The invention includes a combined elevation and tilt mechanism for the beam-splitter mirror assembly, as well as allowing for variable mounting locations for the camera. A channel is also provided for the camera mounting plate that allows the camera to slide. The channel can also allow for the attachment of an adjustable position counter weight.

It is an object of the present invention to provide a quick, tool free method for adjusting both the height and angle of the beam splitter mirror assembly for use with variously sized cameras.

A further object of this invention is to provide preset stops for quickly adjusting the beam splitter mirror assembly height.

A still further object of this invention is to provide a rapid, tool free method for removing the beam splitter mirror assembly for transport.

A still further object of this invention is to provide the beam splitter mirror assembly with preset angle stops for operating position, storage positions as well as intermediate angles as needed.

Another object of the present invention is to utilize custom extrusions for the camera plate and monitor plate to provide a channel system that offers rapid, tool free, adjustment of camera position, monitor position and teleprompter mounting.

A further object of this invention is to provide a dual height teleprompter mounting configuration that lowers the center of gravity of the apparatus. This allows large cameras to utilize lighter, less expensive tripod heads, and provides a broader, more accurate range of balancing for teleprompter mounting.

A still further object of this invention is to provide a quick, tool free method for the addition of accessories including camera lock mechanisms, counter weights, feedback monitors, battery packs, video transmitters and shoulder pads.

A still further object of this invention is to provide a quick, tool free means to allow topside control of camera position with a preset lock to avoid the camera lens from breaking the beam splitter mirror during camera position adjustment or inadvertent movement during camera panning and tilting.

### 2. BRIEF DESCRIPTION OF THE DRAWINGS

FIG. 1 is a schematic illustration of the principles of operation of a teleprompter.

FIG. 2 is a front isometric view of the teleprompter with a video camera in place.

FIG. 3 is a top rear isometric view of the teleprompter without a video camera installed.

FIG. 4 is an underside rear view isometric of the teleprompter with a tripod mount on the camera rail.

FIG. 5A is side view with a heavy weight camera and a tripod attached to the camera rail.

FIG. 5B is the side view of FIG. 5A with a lightweight camera and with the tripod attached to the display rail.

FIG. 6A is a side view describing the mirror tilt-elevate mechanism.

FIG. 6B is an enlarged detail view of the tilt-elevate mechanism of FIG. 6A.

FIG. 6C is a cross-sectional view of the mechanism of FIG. 6B.

FIG. 6D is an enlarged exploded view of the tilt-elevate mechanism.

FIG. 7 is side view of the teleprompter collapsed for storage.

FIG. 8A is an enlarged section view of FIG. 7 through the camera rail showing both camera and tripod trucks.

FIG. 8B is an exploded isometric view of the camera truck shown in FIG. 8A.

FIG. 9 is an exploded isometric view of a tripod mounting device for teleprompters.

FIG. 10 is an isometric view of a teleprompter utilizing a typical very light, small mini-camera.

FIG. 11 is an exploded isometric view of dual-step riser with mini-camera.

FIG. 12 is an isometric view of a second version of the teleprompter.

FIG. 13 is an isometric view of the teleprompter of FIG. 12 in which the beam-splitter is detached.

FIG. 14 is an enlarged detail view of the rail spacer and beam-splitter mounting means of FIG. 13.

### 3. DETAILED DESCRIPTION OF THE DRAWINGS

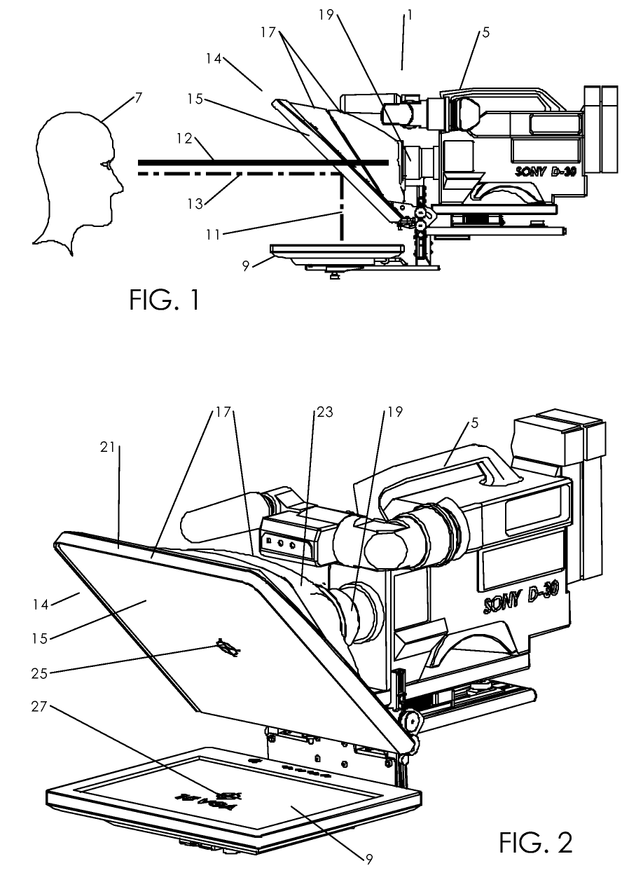

FIG. 1 schematically represents a teleprompter 1 with a camera 5 installed. The teleprompter 1 is being used by a presenter 7. A mirror-hood assembly 14 is shown comprising a beam-splitting mirror 15, an enclosing hood 17, and a computer driven display 9 whose screen image 11 is reflected along path 13 by the beam splitter 15 toward the presenter 7 who is reading the text (not shown) that is being slowly scrolled on the display screen 9. The beam splitting mirror 15 is normally set at a nominal 45 degrees from the screen of the display 9. The camera lens 19 is shown directly behind the semi-transparent beam splitter 15 and records an image of the presenter 7 along an optic centerline 12 of the video camera 5 as he delivers the text message. The hood 17 covers the camera 5 side of the beam splitter 15 to exclude light which would interfere with the clear reflection of the display image. Since the presenter 7 is looking directly at the lens 19 centered behind the reflected text, it will appear to a viewing audience that the presenter 7 is not reading, but is speaking extemporaneously. The viewer appears to be in direct eye contact with the presenter.

FIG. 2 is an isometric front view of the preferred embodiment of the invention. The hood 17 is composed of two parts, a fixed enclosure 21 and a fabric or conformable hood 23. The conformable hood 23 is required to be able to adapt intimately to the many shapes and positions of the lens 19 of the attached camera 5. It is essential that all light be excluded from the space defined by the backside of the beam splitter 15 and the camera lens 19. The conformable hood 23 is closed by a drawstring (not shown) to ensure intimate contact with the camera lens 19. In many of the illustrations to follow the conformable hood 23 will be omitted for purposes of clarity. The location of the display 9 is set by the operator so that a display image center 27 is directly below the beam-splitter geometric center 25. In this way the presenter 7, who generally reads his message at the mid-point of the scrolling test will be in close eye contact with the center of the beam-splitter 25. This effect is illustrated in FIG. 1 where the presenter eye vector is along the video camera optic centerline 12. The optic centerline 12 is also coincident with the aforementioned beam-splitter center 25.

FIG. 3 is an isometric rear view of the invention with the fabric hood 23 omitted for clarity. The camera 5 is not shown in this illustration. The equipment mounting chassis 30 is formed of a camera rail 31 and a display rail 33 connected by a rail spacer 35. The camera rail 31 has a longitudinal tee-slot 37 formed the full length of the upper surface. A camera truck 39 is attached to the tee-slot 37 by tee-nut means to be described later. The camera truck 39 will be shown to be capable of being positioned and locked at any longitudinal point along the camera rail 31. The rail spacer 35 has a pair of rail spacer wings 43 extending both sides of equipment chassis 30. Attached to each spacer wing 43 is a vertically oriented mirror pillar 45 having an outward facing longitudinal tee-slot.

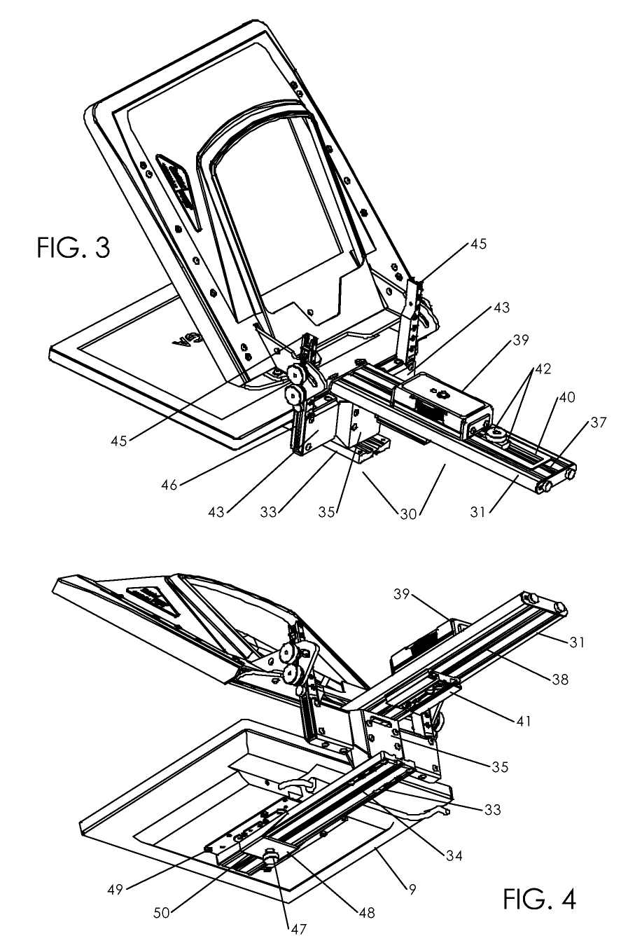

FIG. 4 is an isometric underside view of the invention. Attached to the underside of the first horizontal rail 31 is a tripod truck 41. The tripod truck 41 will be shown later to attach to the first horizontal rail 31 by engaging the t-slot 38. A display truck 43 attaches to the underside of display monitor 9 by machine screws and wraps around the second horizontal rail 33 and is in turn locked in place by thumbscrew 47. A display mounting bracket 48 is shown in FIG. 4 that is attached to the display monitor 9 by mounting screws 49. The mounting bracket 48 has a tunnel feature 50 through which the second horizontal rail 33 passes constraining the allowable motion of the display 9 to be lengthwise along the second horizontal rail 33. The position that the display 9 resides is adjustably fixed by a clamping thumbscrew 47.

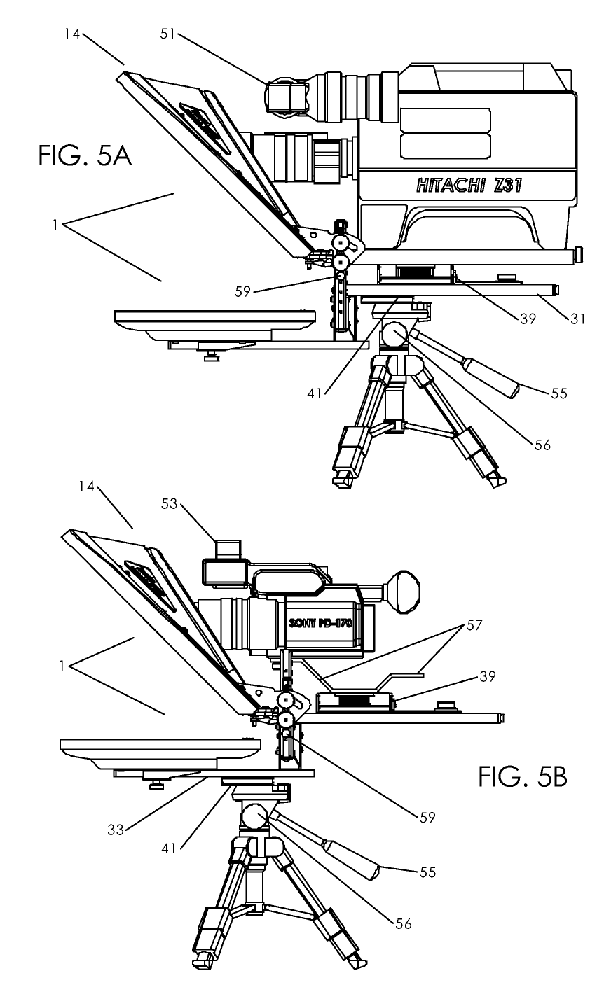

FIG. 5A is a left side view of the invention. In this view a heavy camera 51 is attached to the camera truck 39. A tripod 55 is attached to tripod truck 41 and the tripod truck 41 is locked to the first horizontal rail 31 in a position such that a tripod pivot 56 is directly underneath the center of gravity of the entire Teleprompter assembly 1 including the camera 51.

FIG. 5B is the view of FIG. 5A with the substitution of a lightweight camera 53 in place of the heavy camera 51. The lightweight camera 53 is mounted onto a dual height riser 57. In this case the center of gravity of the Teleprompter assembly 1 with light camera 53 has shifted to the left. The tripod truck 41 therefore now mounts into the tee-slot 34 on the underside of the second horizontal rail 33. The tripod truck 41 is so positioned on the display rail 33 such that the tripod pivot 56 is still directly beneath the left-shifted center of gravity of the Teleprompter assembly 1.

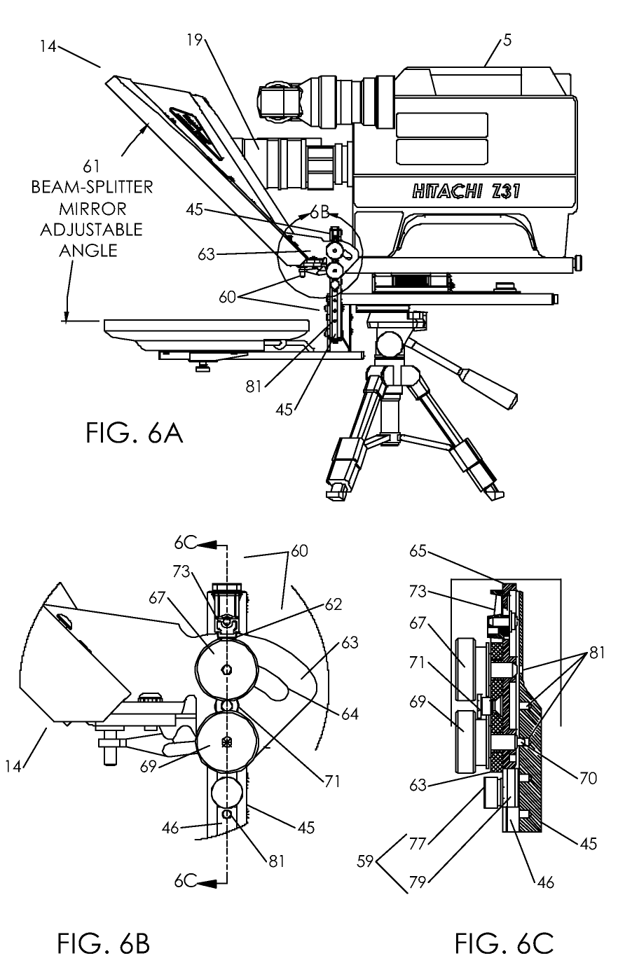

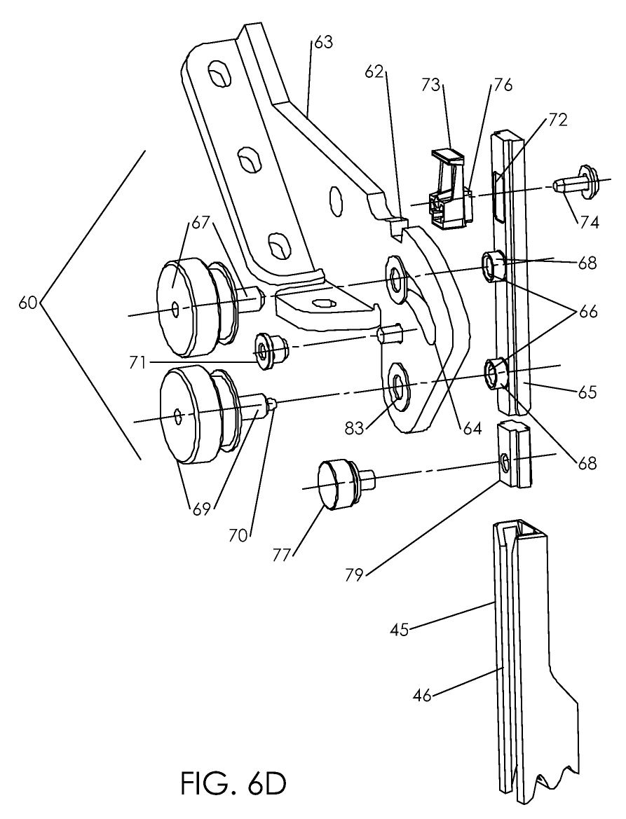

FIG. 6A through 6D illustrates a mirror lift/tilt mechanism 60 utilized in this embodiment of the present invention. Referring to FIG. 6A observe the beam-splitter adjustable angle 61. This angle adjustment along with the capability to raise and lower the mirror-hood assembly 14 is made possible by the mechanisms of lift-tilt mechanism 60 which will be described in FIGS. 6B through 6D.

Referring to 6B and 6C the lift-tilt mechanism 60 as well as mirror pillar 45 is duplicated in mirror image (not shown in these figures) about the vertical, longitudinal center plane of the equipment chassis 30 shown in FIGS. 6B and 6C. A pair of hinge sectors 63 are fixedly attached to mirror-hood assembly 14.

Referring now to the exploded view FIG. 6D notice that an elevation stop tee-nut 79 as well as a mirror tee-nut 65 slideably engage the tee-slot 46 in the mirror pillar 45. The tee-nut 79 is set and locked in the tee-slot 46 by elevation stop thumbscrew 77 in a vertical position that centers the camera lens 19 (neither shown in this view) horizontally on the mirror geometric center. When locked the tee-nut 49 abuts the mirror tee-nut 65 at the proper mirror height.

The mirror tee-nut 65 features a pair of bearing bosses 68 through which are tapped holes 66. There is also a slider slot 72 passing completely through tee-nut 65. A detent tilt slider 73 has a rectangular boss 76 extending from the underside. Rectangular boss 76 passes through the slider slot 72 and is attached to the mirror tee-nut 65 by a detent retaining screw 74. Detent screw 74 is tightened to a torque value that permits the detent slider 73 to be moved up or down with a moderate degree of friction.

The hinge sector 63 contains an arcuate sector slot 64 centered about a pivot hole 83. The pivot hole 83 engages the lower bearing boss 68 for free rotation. The upper bearing boss 68 passes loosely through the sector slot 64. A pivot lockscrew 69 threads into the lower tapped bearing boss 68. A sector lockscrew 67 threads into the upper tapped bearing boss 68. An extraction stop 71 is screwed to hinge sector 63 and engages the wide slots in the lockscrews 67 and 69. the purpose of the extraction stop 71 is to prevent total removal of the lockscrews 67 and 69.

Returning to FIG. 6C which shows a cross-section of the lift-tilt mechanism 60 assembled into the tee-slot 46 of pillar 45. When the lockscrews 67 and 69 are tightened the lift-tilt mechanism 60 is rigidly clamped to pillar 45.

Pillar 45 has an array of detent sockets 81 spaced vertically in the bottom of pillar tee-slot 46. A detent pin 70 protrudes from the threaded end of the lockscrew 69. When the mirror-hood assembly 14 is raised or lowered to a new vertical location the detent pin 70 engages one of the detent sockets 81.

Turning now to FIG. 6B, observe that the detent tilt slider 73 is engaged in the detent notch 62 on hinge sector 63. When the slider 73 is so slotted into notch 62 then the beam-splitter mirror (not shown) is at a 45 degree angle; an image reflection angle that is employed for most teleprompter usage.

Under some circumstances, usually driven by the presenter (talent), it is desirable to orient the beam splitter 14 a few degrees up or down from the optimal 45 degrees. When this is required the lockscrews 67 and 69 are loosened slightly and the slider 73 is raised out of the detent notch 62. The mirror may now be adjusted up or down to suit and then locked firmly into place.

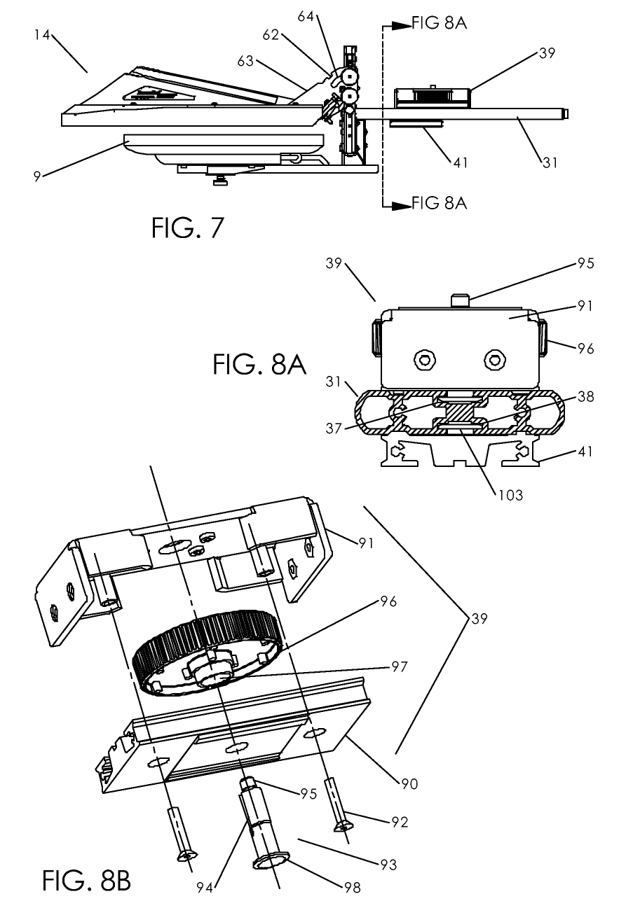

FIG. 7 illustrates a important feature. When the teleprompter is “on the road” or packed away for storage it occupies a great deal of space because of the diagonally upward orientation of the mirror-hood assembly 14. In this illustration the mirror-hood 14 is lowered to the “lay flat” position. The length of sector slot 64 in hinge sector 63 is sized such that the mirror cannot go beyond the horizontal position. This limitation prevents mirror or display damage in the event of rough handling. It is obvious that this unit can be packed into a relatively economical space.

FIGS. 8A and 8B shows the camera mounting truck 39 in detail. The camera truck 39 mounts atop the camera rail 31 which, in the preferred embodiment, is formed from an extrusion. The extrusion is chosen for its low weight and strength as compared to a solid bar. The camera truck 39 attaches to the first horizontal rail 31 by means of a clamp spindle 93 which engages with the tee-slot 37 in first horizontal rail 31.

Clearly shown in FIG. 8B, the clamp spindle 93 has a mushroom head 98 that slides into the tee-slot 37 as shown in FIG. 8A. The clamp spindle 93 also has a longitudinal keyway 94 and a threaded stud 95 at the upper end. The clamp spindle 93 passes through a bearing hole in a camera truck base block 90 and in turn passes through a keyed internal bore 97 in a knurled clamp knob 96. The key in the internal bore 97 is not shown in these drawing figures. The parts of camera truck 39 are contained by a cover 91 attaching to the base block 90. The cover 91 is attached to the base block 90 by means of a pair of screws 92.

In operation the camera 51 (not shown in FIG. 8A or 8B) is attached to the camera truck 39 by a threaded socket on the camera underside. This tapped socket engages the threaded stud 95. As knurled clamp knob 96 is rotated the keyed clamp spindle 93 also rotates and draws the camera 51 down onto the top surface of the camera truck 39. As the camera 51 is pulled downward the clamp spindle 93 is also drawn upward until the mushroom head 98 grips into the tee-slot 37. Continued rotational torque applied to knurled clamp knob 96 thus rigidly clamps both camera 51 to the camera truck 39 and the camera truck 39 to the first horizontal rail 31.

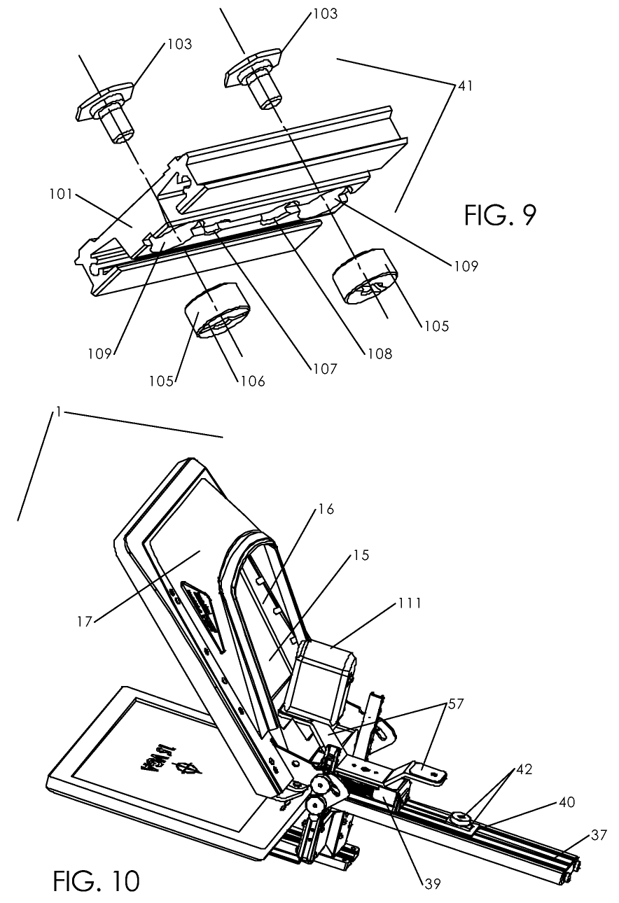

FIG. 9 shows the details of construction of the tripod truck 41 whose body 101 has a pair of counter-bored holes 109. Body 101 also has a ¼-20 tapped socket 107 as well as a ⅜-16 threaded socket 108. These threaded sockets are the two internationally utilized sizes with which tripods are equipped. A pair of tee-studs 103 having threaded protrusions pass through the counter-bored holes 109 and are secured by a pair of threaded clamp nuts 105. The clamp nuts 105 each have a slot 106 so that the nuts 106 can tighten the tee-studs 103. When installed the clamp nuts 105 are fully contained within the counter-bores 109.

Referring back to FIG. 8A the tripod truck 41 is secured to the underside of the first horizontal rail 31 by the tee-studs 103 engaging the tee-slot 38. FIG. 4 illustrates the tee-slot 34 on the underside of second horizontal rail 33. This tee-slot 34 is identical to the tee-slot 38 in first horizontal rail 31. This arrangement allows the placement of tripod truck 41 on either the first horizontal rail 31 or on the second horizontal rail 33 as shown in FIG. 5B. Importantly this feature allows placement of the tripod pivot 56 to be directly under the system center of gravity.

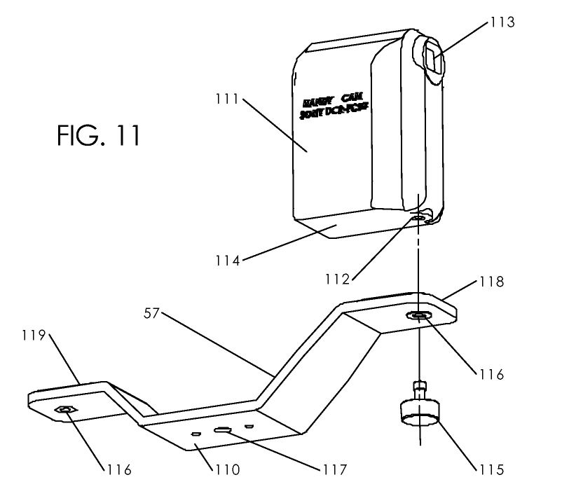

FIG. 10 shows a teleprompter 1 with a very lightweight mini-camera 111 mounted on one leg of the dual height camera riser 57. FIG. 11 shows some details of a typical light weight mini-camera 111, in this case a Sony DCR-PC-55. The notable features of many of this class of camera is that the camera mounting socket 112 is very close to the front of the camera and the camera lens 113 is almost flush with the front camera surface as well as being a relatively great distance from the camera mounting surface 114. The significance of these dimensional parameters will be described shortly.

FIG. 11 illustrates the mini-camera 111 attached to the dual-height riser 57 by a threaded thumbscrew 115 passing through a camera mount hole 116 (one of two) and engaging the threaded camera mounting socket 112. Riser 57 has two camera mounting surfaces, a top level riser leg 118 and a low level riser leg 119. For purposes of reference the present embodiment the top level leg 118 is 2 inches above a riser mounting surface 110 and the low level leg 119 is 1 inch above. These dimensions are not fixed and the riser 57 mounting levels can be modified to accommodate any given cameras.

Referring back to FIG. 10 the camera riser 57 is shown with the mini-camera 111 mounted to the camera truck 39. The threaded stud 95 of FIG. 8A clamps the riser 57 by threading into a riser attachment socket 117.

Compare now the relative locations of the mini-camera 111 of FIG. 10 to the large camera 5 in FIG. 6A. In FIG. 6A it can be seen that the lens 19 extends far forward of the body of the camera 5. In FIGS. 10 and 11 the lens 113 is nearly flush with the front of the body of camera 111 and the mounting hole 112 is only a short distance behind the lens. The consequence of this is that, without the elevation and extension of riser legs 118 and 119 the camera will not be able to be positioned close to the beam-splitting mirror 15. If the lens of a camera is not close to the beam-splitter the rectangular optic picture cone (not shown) can be obscured by the mirror support frame 16. Thus the extension and elevation of the riser legs 118 and 119 enables the lenses of certain cameras, when required, to extend deeply into the hood opening and be setup as close as possible to the beam-splitter 15.

Turning back to FIG. 10, the camera stop 42 is locked into the tee-slot 37 at a position where it encounters the inside end of the camera stop link 40 at a location to position the camera 111 as close as possible to the beam-splitter 15. When it is desired to remove the camera 111 from the teleprompter, the camera truck 39 with it's attached stop link 40 is dragged to the right for camera removal clearance (not shown). The reverse action is performed to reinstall the camera 111 and quickly reposition it with respect to the beam splitter mirror 15.

The mirror stop assembly 59 of FIG. 5B is also shown in the detail view of FIG. 6C. The stop assembly 59 is composed of elevation tee-nut stop 79 and the thumbscrew 77 which combine to tightly clamp into the pillar tee-slot 46. The mirror tee-nut 65 is limited in its downward travel by the locked position of the mirror stop 59.

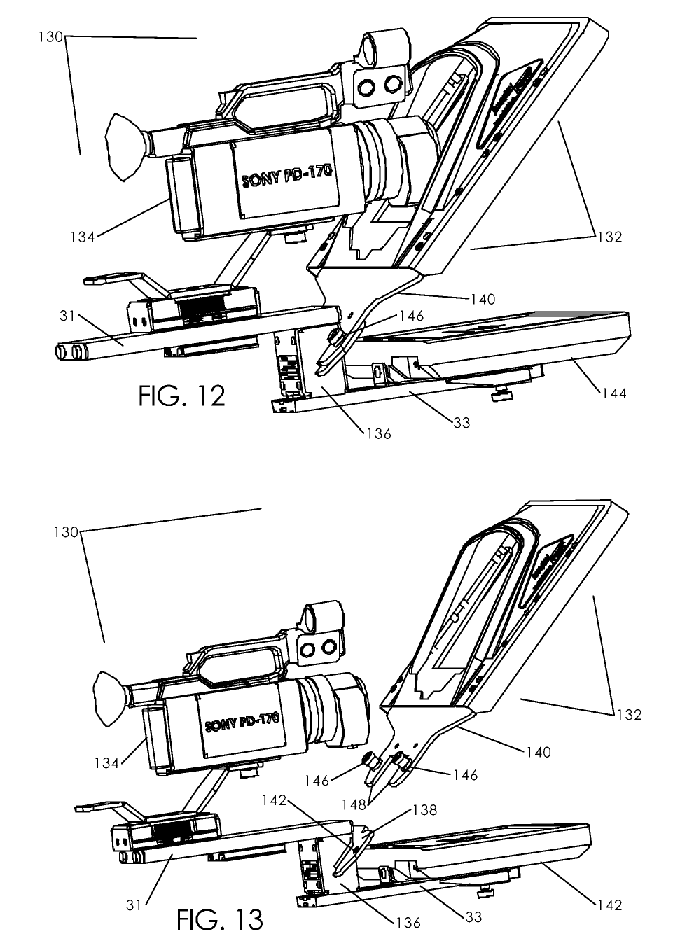

FIG. 12 shows a simplified teleprompter 130 in which some of the previously described teleprompter features have been omitted. Some segments of the marketplace have a need for a simpler version of the prompter. One such use is for lower level schools where multiple sizes and weights of cameras are not normally experienced. Another school requirement lies in the need for ease and simplicity of setup for younger operators. Another justification, in light of current educational budgeting levels, is the lower cost associated with a simpler apparatus. The field use of a teleprompter is also another important application for the simplified teleprompter 130, wherein the teleprompter/camera assembly is supported on the cameraman's shoulder rather than on a tripod. In such cases the lighter weight and ruggedness of the simplified teleprompter 130 are valuable characteristics.

The simplified teleprompter 130 of FIG. 12 has all of the previously described teleprompter attributes except for the tilt mechanism and the beam-splitter raising and lowering mechanism. In place of the previously described rail spacer 35 and its associated pillar structure, this teleprompter version couples a simplified rail spacer 136 to the second horizontal rail 31 and to the first horizontal rail 33 to create the offset rail structure similar to that previously described.

FIG. 13, a partially exploded view of FIG. 13, shows the simplified teleprompter 130 with a simplified mirror/hood assembly 132 detached a short distance from the overall apparatus. This mirror/hood assembly 132 is attached, in its operating location in FIG. 12 to the full simplified teleprompter 130.

The simplified mirror-hood assembly 132 is similar to the previously described mirror-hood assembly 14 except for the means of attaching it to the rest of the teleprompter. The simplified mirror-hood 132 has a beam-splitter mounting plate 140 which terminates in a forked pair of slot engagement wings 148. Either side of the engagement wings have a pair of threaded thumbscrews 146 passing through holes in the engagement wings 148. In the present invention these thumbscrews 146 are captive and spring biased upward for ease of use. Many other types of screw or latching devices could be substituted for the threaded thumbscrews 146.

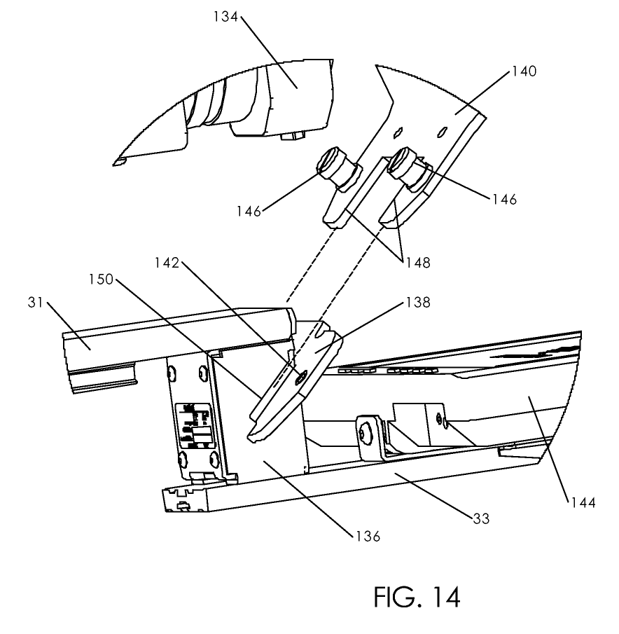

FIG. 14 is an enlarged partial view of FIG. 13 where in the simplified rail spacer 136 has a mirror attachment plate 138 welded to the rail spacer 136 at an angle of 45 degrees. Other angles are possible but 45 degrees is the most useful and universal. The attachment plate straddles the rail spacer 136 such that the hidden far side of FIG. 14 is a mirror image of the side shown. A mirror engagement slot 150 is cut into both sides of the rail spacer 136. The mirror attachment plate 138 has a pair of threaded sockets 142 on each side.

Whereas the mirror-hood assembly 132 is shown detached in FIG. 13, it is shown locked into its functioning position in FIG. 12. The engagement slots 150 shown in FIG. 14 are slightly wider than the thickness of the engagement wings 148. Therefore as the mirror-hood assembly 132 is being re-assembled the engagement wings 148 slide smoothly into the engagement slots 150. The threaded thumbscrews 146 are then tightened into the threaded sockets 142 to rigidly couple the mirror-hood 132 to the rest of the mechanism.

### 4. INDEX OF DRAWING NUMBERS

1—Teleprompter unit with display, beam splitter, and hood
5—Video or film camera
7—Presenter/Talent
9—Electronic Display monitor
11—Optic rays representing the image, or scrolling text, as formed on the display screen.
12—Optic centerline of video camera recorded image
13—Optic path of the reflected display image
14—Mirror-Hood assembly
15—Semi-transparent beam splitting mirror
16—Support frame, beam-splitter
17—Enclosing hood to exclude extraneous light behind the beam splitter and the camera lens
19—Camera lens
21—Fixed hood enclosure. Part 1 of a 2-part light excluder
23—Conformable hood. Part 2 of the 2-part light excluder
25—Geometric center of the beam-splitter mirror 15
27—Geometric center of the display image
30—Equipment chassis
31—First horizontal rail
33—Second horizontal rail
34—T-slot on the lower surface of the second horizontal rail
35—Vertical Rail spacer
37—T-slot on the upper surface of the first horizontal rail
38—T-slot on the lower surface of the first horizontal rail
39—Camera mount truck
40—Camera stop link
41—Tripod mount truck
42—Camera stop assembly
43—Spacer wings
45—Vertical pillar
46—T-slot in vertical pillar
47—Thumbscrew
48—Display mounting bracket
49—Mounting screws
50—Mounting bracket rail tunnel
51—Heavyweight camera
53—Lightweight camera
55—Tripod
56—Tripod pivot center axis
57—Dual height camera riser
59—Mirror Elevation Stop Assembly
60—Lift/tilt mechanism
61—Beam-splitter adjustable angle
62—Detent notch, mirror tilt
63—Hinge sector
64—Sector slot
65—Tee-nut, mirror
66—Tapped holes, tee-nut
67—Sector lockscrew
68—Bearing bosses, tapped
69—Pivot lockscrew
70—Lockscrew detent pin
71—Extraction stop
72—Slider slot
73—Detent tilt slider
74—Detent retaining screw
76—Rectangular boss
77—Thumbscrew, elevation stop
79—Tee-nut, elevation stop
81—Elevation detent socket array, pillar
83—Pivot hole
90—Base block, camera truck
91—Cover, camera truck
92—Screw
93—Clamp spindle
94—Keyway, clamp spindle
95—Threaded stud, camera mounting
96—Clamp knob, knurled
97—Keyed internal bore
98—Mushroom head, clamp spindle
101—Body, tripod truck
103—Tee-stud, tripod truck
105—Clamp nut
106—Clamp slot
107—¼-20 threaded socket
108—⅜-16 threaded socket
109—Counter-bored hole
110—Riser mounting surface
111—Mini-camera
112—Mounting socket, mini-camera
113—Lens, mini-camera
114—Camera mounting surface
115—Threaded thumbscrew
116—Riser camera mount hole
117—Threaded riser attachment socket
118—Top level riser leg
119—Low level riser leg
130—Simplified teleprompter with camera and display
132—Simplified mirror-hood assembly
134—Camera
136—Simplified rail spacer
138—Mirror attachment plate
140—Beam-splitter mirror mounting plate
142—Threaded socket, mirror mounting plate
144—Display
146—Threaded thumbscrew, mirror mount
148—Slot engagement wings
150—Mirror engagement slot (1 of 2)

What is claimed:

1. A teleprompter for use with a video camera, comprising:
a. an electronic display monitor capable of displaying information;
b. a chassis comprising:
i. a means to support a camera, wherein the camera comprises a lens;
ii. a means to support an electronic display;
c. a beam splitter mirror, wherein the beam splitter mirror is
i. vertically adjustable to allow alignment between itself and the camera;
d. a tilt mechanism attached to the beam splitter mirror; and
e. a hood assembly attached to the tilt mechanism.

2. The teleprompter of claim 1, wherein the means to support the camera comprises a first horizontal rail, and wherein the means to support the electronic display comprises a second horizontal rail.

3. The teleprompter of claim 2, wherein the first horizontal rail and the second horizontal rail are attached to each other by a vertical rail spacer in a non coplanar arrangement.

4. The teleprompter of claim 3, further comprising one or more vertical pillars attached to the vertical rail spacer.

5. The teleprompter of claim 4, wherein the first and second non coplanar rails each have an upper surface and a lower surface.

6. The teleprompter of claim 5, wherein the first horizontal rail further comprises a means of securing a camera to the first horizontal rail, wherein the camera comprises a lens.

7. The teleprompter of claim 4, wherein the beam splitter is further supported by the one or more vertical pillars.

8. The teleprompter of claim 4, wherein the tilt mechanism is further attached to the one or more vertical pillars.

9. The teleprompter of claim 4, wherein the tilt mechanism comprises a means to adjust the angle between the beam splitter mirror and the one or more vertical pillars.

10. The teleprompter of claim 9, wherein the hood assembly is attached to the tilt mechanism via the vertical pillars.

11. The teleprompter of claim 1, wherein the tilt mechanism further comprises a means to lock the beam splitter mirror at a 45 degree angle to the camera lens.

12. The teleprompter of claim 5, wherein the second horizontal rail allows the electronic display to adjust location by sliding along the second horizontal rail.

13. The teleprompter of claim 6, wherein the means of securing the camera to the first horizontal rail comprises a T-slot located on the upper surface of the first horizontal rail.

14. The teleprompter of claim 6, further comprising a means to adjust the location of the camera along the first horizontal rail.

15. The teleprompter of claim 14, wherein the means to adjust the location of the camera along the first horizontal rail comprises a T-slot located on the upper surface of the first horizontal rail.

16. The teleprompter of claim 1, wherein the means of securing the electronic display monitor comprises a mounting bracket located on the second horizontal rail.

17. The teleprompter of claim 1, wherein the means to support a camera comprises a camera mount attached to the upper surface of the first horizontal rail.

18. The teleprompter of claim 3, further comprising a tripod mount attached to the lower surface of the first horizontal rail.

19. The teleprompter of claim 3, further comprising a tripod mount attached to the lower surface of the second horizontal rail.

20. The teleprompter of claim 6, wherein the T-slot located on the upper surface of the first horizontal rail further comprises a locking knob, wherein said locking knob is capable of securing the camera to the upper surface of the first horizontal rail.

21. The teleprompter of claim 4, further comprising reference scales on each vertical pillar, wherein said scales are calibrated to camera lens center height measurements.

22. The teleprompter of claim 4, further comprising a plurality of detent holes located in each of the one or more vertical pillars.

23. The teleprompter of claim 4, further comprising a plurality of stop devices insertable into the T-slots of the one or more vertical pillars.

24. The teleprompter of claim 17, further comprising a dual level riser located on the camera mount.

25. A teleprompter for use with a video camera, comprising:
a. an electronic display monitor capable of displaying information;
b. a chassis comprising:
i. horizontal first and second non coplanar rails, wherein the first horizontal rail and the second horizontal rail are separated by a vertical rail spacer;
ii. wherein the first and second non coplanar rails each have an upper surface and a lower surface;
iii. wherein the first horizontal rail comprises a means of securing a camera to the first horizontal rail, wherein the camera comprises a lens;
iv. wherein the second horizontal rail comprises a means of securing the electronic display monitor; and
c. a hood assembly, comprising an integral beam splitter mirror, wherein the hood assembly is attachable to a slot in the vertical rail spacer, creating a 45 degree angle between the hood assembly and the camera lens.
